(19) United States
(12) Patent Application Publication
(10) Pub. No.: US 2012/0117385 A1
(43) Pub. Date: May 10, 2012

(54) METHOD AND APPARATUS FOR DATA ENCRYPTION

(75) Inventor: Donald Lovell Bryson, Chattanooga, TN (US)

(73) Assignee: International Business Machines Corporation, Armonk, NY (US)

(21) Appl. No.: 12/942,138

(22) Filed: Nov. 9, 2010

(51) Int. Cl. H04L 9/32

(52) U.S. Cl. 713/168

(57) ABSTRACT

Embodiments of the invention relate to message based encryption and authentication to support secure communication of a message. A time stamp embedded within the message is evaluated to ensure that a received message has not been subject to a significant time delay. More specifically, tools are employed to evaluate the authenticity of the message subject to the characteristics of the embedded time stamp. A message subject to a time delay is considered to be tainted and is not authenticated for receipt by a target device.

### BACKGROUND

This invention relates to data encryption in a communication system. More specifically, the invention relates to encryption of messages in the system and time based allocation to support and verify the messages.

Data encryption refers to translation of data into a secret code in order to achieve data security. To read an encrypted file, the recipient of the file must have access to a key or password that supports decoding of data that has been encrypted, i.e. decryption of the file. Both the password and key supported encryption are known encryption techniques. A password is known as a form of symmetric encryption and it employs a series of characters that enables access to the encrypted file. A key is known as a form of asymmetric encryption and it employs two keys, a public key known to the sender and recipient of the message and a private key known only to the recipient of the message. With the key based system, the sender of the message encrypts the message with the public key of the recipient, and the recipient uses their private key to decrypt the message. The public and private keys are related so that only the public key can be used to encrypt the message and only the corresponding private key can be used to decrypt the message.

The data and message encryption system is configured to encrypt messages, so that the recipient is ensured of the confidentiality of the received message. Encryption is used for a plurality of environments, with the goal of maintaining data confidentiality. At the same time, it is known that there may be computer enthusiasts who try to intercept encrypted messages. A slang term for such a computer enthusiast is a hacker. The recipient of an intercepted message may not know that the message has been intercepted. In an asymmetric encryption model, the recipient of an intercepted or non-intercepted message would continue to use their private key to decrypt the message.

### BRIEF SUMMARY

This invention comprises a method, system, and article for transmitting an encrypted message across a network, and for performing verification of the encrypted message as a message security technique.

In one aspect of the invention, a method is provided for transmitting a message from a first communication device to a second communication device. The transmitted message includes an encrypted time stamp. Prior to acceptance of the message, the time stamp is verified, and it is determined if the verified time stamp falls within a predetermined time interval. The second communication device accepts the message if it has been determined that the time stamp does fall within the predetermined time interval. Similarly, the second communication device rejects the message if it has been determined that the time stamp does not fall within the predetermined time interval.

In another aspect of the invention, a system is provided with a first communication device and a second communication device in communication across a network. A first message is transmitted from the first communication device to the second communication device. The first message includes an embedded encrypted time stamp. A verification manager is provided to verify the time stamp, and to determine if the verified time stamp falls within a predetermined time interval. An acceptance manager is provided local to the second communication device to direct acceptance of the message in response to the verification manager's determination that the time stamp does fall within a predetermined time interval. In addition, a rejection manager is provided local to the second communication device and is responsible for directing a rejection of the message in response to the verification manager's determination that the time stamp does not fall within the predetermined time interval.

In yet another aspect of the invention, a computer program product is provided with a computer readable storage medium having embodied computer readable program code. More specifically, computer readable program code is configured to transmit a message from a first communication device to a second communication device. The message includes an encrypted time stamp. Computer readable program code is provided to verify the time stamp and to determine if the verified time stamp falls within a time interval. If the time stamp does fall within the predetermined time interval, then the second communication device accepts the message. Conversely, if the time stamps does not fall within the predetermined time interval, then the second communication rejects the message.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flow chart illustrating use of an encrypted time stamp as an authentication tool.

FIG. 2 is a flow chart illustrating use of a group password with a time stamp as an authentication tool.

FIG. 3 is a flow chart illustrating a process for group member authentication.

FIG. 4 is a block diagram of tools to support time stamp encryption and authentication.

FIG. 5 is a block diagram illustrating tools to support time stamp encryption and authentication between two communication devices.

FIG. 6 is a block diagram showing a system for implementing an embodiment of the present invention

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as managers. A manager may be implemented in programmable hardware devices such as field programmable gate arrays, programmable array logic, programmable logic devices, or the like. The manager may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

A communication system comes in many different forms and configurations. In each form, one or more devices are configured to transmit and receive messages across a communication network. There are different architectural approaches to computer based communication systems. In a communication system that supports transmission of encrypted messages or messages with encrypted data, one or more tools are provided to manage the encrypted element and authentication thereof. In one embodiment, a time stamp associated with the message is employed as a verification element within the authentication of the encrypted element. A time stamp is the time of day recorded in a transaction. In one embodiment, the current time is maintained by a computer in fractions of a second and is used for a variety of synchronization purposes, including determining transaction order in the event of a system failure. All transmitted messages contain time stamp data. In one embodiment, the time stamp is embedded in the header portion of an electronic message. Accordingly, leveraging the time stamp to authenticate a message transmission leverages data contained within the message minimizing use of extraneous data for authentication of the message.

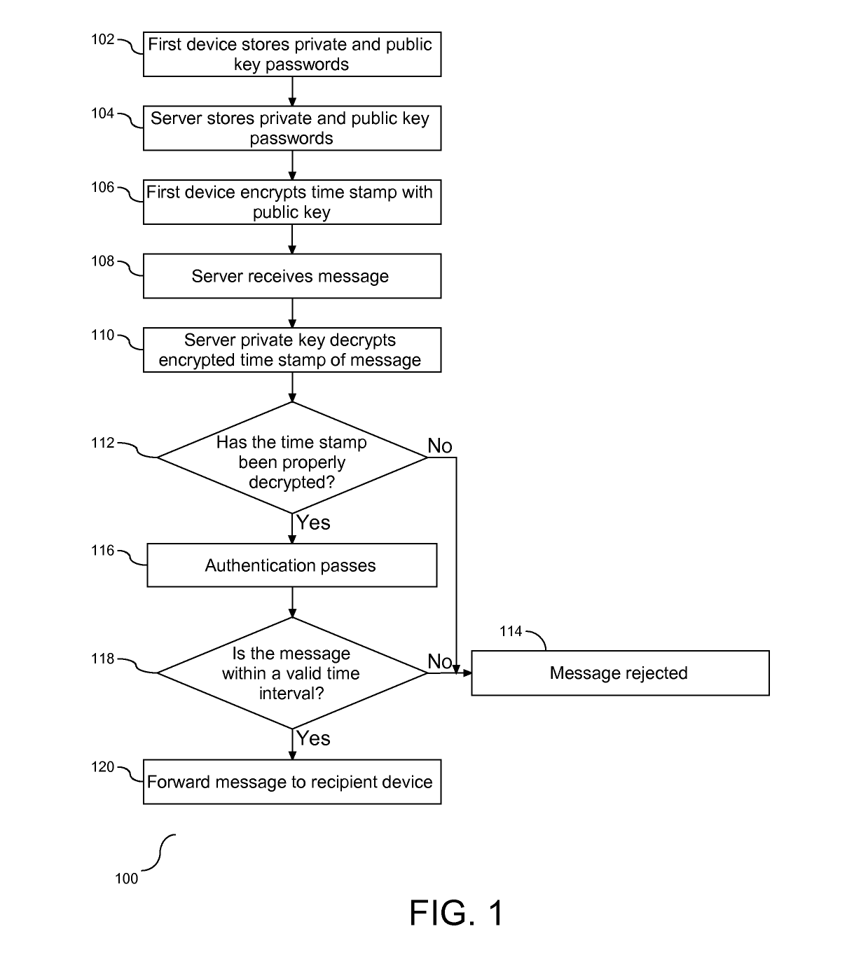

One or more tools and/or algorithms are employed to address use of the time stamp within the message header as an authentication element. FIG. 1 is a flow chart (100) illustrating use of a time stamp as an encrypted portion of a message, and how the time stamp is leveraged for authentication of the message. A first communication device stores a private key password and a public key password (102). The first communication device is in communication with a second communication device across a network. A server is employed to facilitate the sending and receiving of messages between the first and second communication devices. Like the first communication device, the server has its own private key password and public key password (104). A transmitted message includes a time stamp indicating when the message was sent from the first communication device. The first communication device uses the public key of the intended recipient to encrypt the time stamp portion of the message (106). Following receipt of the message by the server (108), the private key of the server is employed to decrypt the encrypted time stamp of the message (110). Since only the proper public key can be used to encrypt the time stamp of the message and only the corresponding private key can be used to decrypt the time stamp of the message, it is determined if the time stamp of the message has been properly decrypted (112). If the authentication of the time stamp of the message at step (112) fails, the receipt of the message is rejected (114). Conversely, if the authentication of the message at step (112) is verified, then the authentication of the message passes (116). Accordingly, the first step in a completed message authentication is employment of the proper public and private keys by the sender and recipient of the message.

Following authentication of the message itself, it is then determined if the message was received within a valid time interval (118). More specifically, to ensure that the private and public keys have not been subject to tampering, the time stamp portion of the message is leveraged as a security element and evaluated to ensure that the message has been transmitted and received within a set time gap. The evaluation of the time interval ascertains the time stamp embedded within the message. In one embodiment, the time stamp is created by the sending device. Similarly, in another embodiment, the time stamp is created by a server utilized to complete transmission of a message between a sending device and a receiving device. The determination at step (118) addresses whether the message has been delayed or whether the message has been received within a reasonable amount of time from when it was originally transmitted. There may be different reasons for a message delay, including network traffic and message interception. Network traffic is not a basis for rejection of a message. However, message interception is a basis for rejecting or accepting a message. Accordingly, the evaluation of the time stamp serves as a barrier for completion of the message transmission to the recipient.

The server does not evaluate the basis for any message delay. Rather, the server evaluates whether the message has been subject to a delay. In one embodiment, the time interval employed by the server for evaluation of the delay may be static. Similarly, in another embodiment, the time interval may be a configurable element, and as such subject to being changed. If at step (118), if it is determined that the verified time stamp falls within a pre-determined interval, then the message is forwarded to the recipient device (120). Conversely, if it is determined at step (118) that the verified time stamp does not fall within the pre-determined interval, then the message is rejected (114), i.e. not transmitted to the recipient device. Accordingly, the verification and evaluation of the time stamp by the server employs time as a factor for completion of a message transmission to a recipient device.

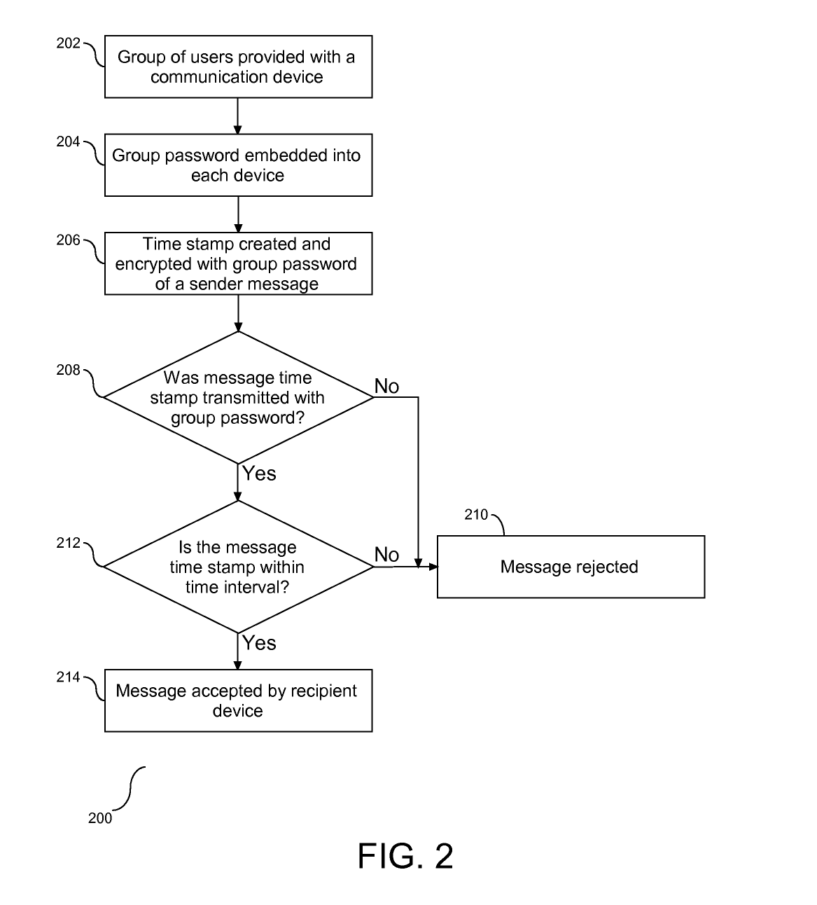

It has become common for users of communication devices to use short messaging service (SMS) either in place of, or in conjunction with, oral communication. Using SMS, a short alphanumeric message can be sent from one communication device to a second communication device. A time stamp authentication system may be employed within an SMS based message. FIG. 2 is a flow chart (200) illustrating a process for authenticating an SMS message based upon an encrypted time stamp. A group of users are each provided with a communication device (202), with each of the communication devices having SMS software local to the device. The SMS software supports encryption and verification of SMS based messages. A group password is embedded into each of the communication devices (204). The group password is a level of security that enables each user in the group to identify a message from another user within the group. Accordingly, the group password is employed as a first level message authentication element within the defined group of communication devices.

When a message is created and transmitted from a sender, a time stamp from the transmission is created and encrypted with the group password (206). In one embodiment, the encryption of the time stamp takes place local to the sending device with the embedded SMS software. When the message is received by the receiving device, the embedded SMS software local to the receiving communication device verifies that the message time stamp was transmitted with the group password (208). If the verification at step (208) indicates that the time stamp was not encrypted with the group password, then the message is not accepted by the receiving device (210). A message may be rejected because the time stamp was not encrypted, or in one embodiment, the password may not have been a correct version of the group password. Conversely, if at step (208) it is indicated that the message time stamp included the group password, it is then determined if the time stamp embedded within the message falls within a pre-defined interval (212). The evaluation of the time stamp determines whether the message has been delayed or whether the message has been received within a reasonable amount of time from when it was originally transmitted. There may be different reasons for a message delay, including network traffic and message interception. Network traffic is not a basis for rejection of a message. However, message interception is a basis for rejecting or accepting a message. Accordingly, the evaluation of the time stamp serves as a barrier for completion of the message transmission to the recipient.

The evaluation at step (212) does not evaluate the basis for any message delay. Rather, the evaluation merely determines whether the message has been subject to a delay. In one embodiment, the time interval employed for evaluation of the delay may be static. Similarly, in another embodiment, the time interval may be a configurable element, and as such subject to being changed. Following the evaluation at step (212), if it is determined that the verified time stamp does not fall within the defined time interval, then the message is not accepted by the recipient device (210). In one embodiment, a message is returned to the sending device indicating the failure of the message. Conversely, if at step (212) it is determined that the verified time stamp does fall within the defined time interval, then the message is accepted by the recipient device (214). In one embodiment, the time stamp embedded within the message may be evaluated prior to the group password evaluation. Regardless of the order of evaluation, both the group password and the time stamp are employed as tools for authentication of a time stamp of the message. Accordingly, the verification and evaluation of the time stamp, and in one embodiment a password, by the communication devices employs time as a factor for completion of a message transmission to a recipient device with the evaluation performed locally by the recipient device.

The process demonstrated in FIG. 2 functions for a small group of users that communicate through SMS based messaging. SMS software is embedded local to each communication device within the group, and all encryption and verification of message time stamps, or the message itself, takes place locally. In a large group of users, it may be necessary to employ a secondary evaluation tool to ensure that the message is from a user within the group. For example, in a large group environment, it may be more likely that a user would leave the group, and that not all of the members of the group will recognize the departure. Accordingly, a security mechanism may be employed to ensure that messages within a group do not include messages from a prior member of the group.

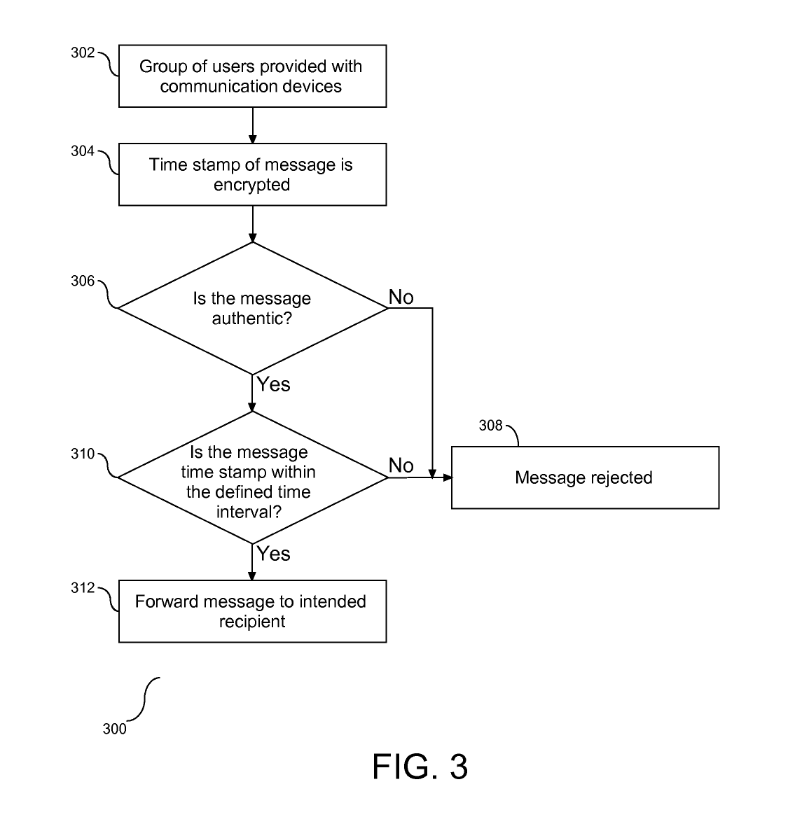

FIG. 3 is a flow chart (300) illustrating a process for authenticating an SMS message based upon the embedded time stamp together with a group member authentication element. A group of users are each provided with a communication device (302), with each of the communication devices having SMS software local to the device. The SMS software supports encryption and verification of SMS based messages. In one embodiment, the public key—private key encryption system is employed, so that each communication device is provided with a unique password to attach to an encrypted communication(s). When a message is created and transmitted from a sender, a time stamp from the transmission is created and embedded within the message. The time stamp is encrypted through the public—private key encryption (304). In one embodiment, the encryption of the time stamp takes place local to the sending device using the key. The message is received and processed by a server for authentication prior to transmission to the receiving communication device (306). More specifically, at step (306) the server verifies the identity of the sending communication device. As noted above, each of the communication devices are registered as members of a group. A device that has been removed from the group should not be able to communicate with the remaining members of the group. At the same time, a group member is able to communicate with the current members of the group. Accordingly, membership within the group is a factor in the message based encryption.

If at step (306) the server determines that the sending communication device is not a member of the group, the message is rejected (308). Conversely, if it is determined that the sending device is a member of the group, the server proceeds to verify the authenticity of the message. In an embodiment where the authenticity is based upon the timestamp of the message, the server verifies the authenticity of the group membership identifier and then determines if the time stamp falls within a pre-defined interval (310). The evaluation of the time stamp determines whether the message has been received within a defined amount of time from when it was originally transmitted. A negative response to the determination at step (310) is followed by a return to step (308). Conversely, a positive response to the determination at step (310) is followed by the server forwarding the message to the intended recipient (312). Accordingly, the evaluation of the message employs a group membership identifier together with the message time stamp as message authentication elements.

In one embodiment, an additional security tier may be employed in the process wherein an additional time stamp is encrypted with a second password used by the final recipient. The first time stamp is authenticated with the server and the initial sending device and the second time stamp is used to authenticate the initial sender with the final recipient.

The encryption method and tools described herein may be employed in various situations. For example, in one embodiment the method and tools may be employed between two or more mobile communication devices. In this embodiment, each of the devices has the requisite software embedded to support encryption of transmitted message and verification of received messages. Similarly, in one embodiment, one of the devices may be an addressable element in a home automation network. In this embodiment, the home automation network contains addressable elements that control delivery of power to individual addressable elements in the network. The transmitted message is encrypted with a time stamp with private key encryption, the device address, and the command code. A server receives the message, and decodes the encrypted time stamp to verify that the message is within a valid age window. The critical aspect of the time stamp prevents forwarding a command code to the addressable element unless the time stamp is within a valid age window. More specifically, if the security of the home automation network has been breached, a message to the server may arrive at the server without an encrypted time stamp. Alternatively, an intercepted message with proper encryption may have a delayed time stamp reflecting that the delay may be caused by a breach in the system. Accordingly, the encryption and verification method and tools are employed to function within a time frame from when a message is transmitted to when the message is received, to verify that the message has not been intercepted by a third party as a means of breaching the security.

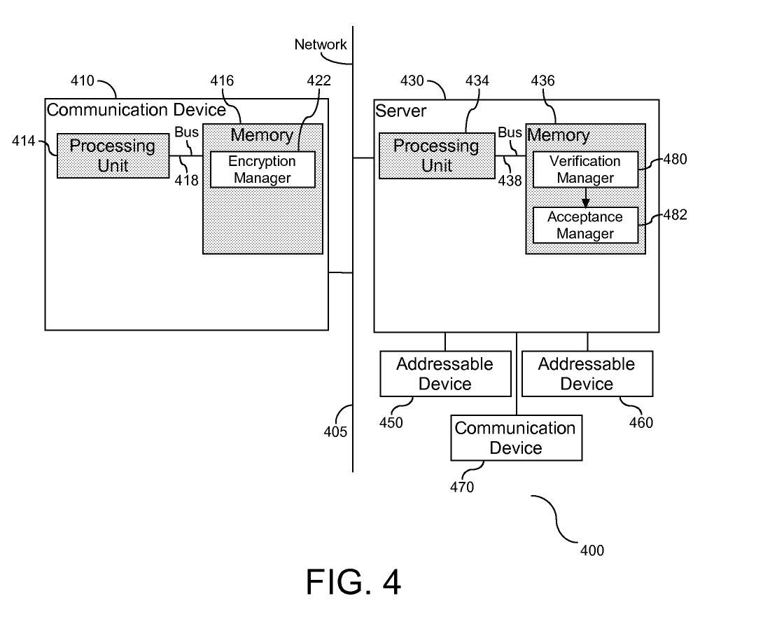

As demonstrated in the flow charts of FIGS. 1-3, a method is employed to support encryption of SMS based messages to verify that the messages are received within a valid age window from when they are transmitted. FIG. 4 is a block diagram (400) illustrating tools embedded in a system to support encryption of SMS based messages for one or more addressable or communication devices. More specifically, a communication system is shown with a first communication device (410) in communication with a server (430) across a network (405). The server (430) is provided with a processing unit (434), in communication with memory (436) across a bus (438). At the same time, server (430) may communicate with one or more addressable devices (450) and (460) and communication device(s) (470). The first communication device (410) is provided with a processing unit (414) in communication with memory (416) across a bus (418). The first communication device (410) is also provided with tools to support transmission and receipt of telecommunication and SMS based messages. The first communication device (410) may communicate with the addressable devices (450) and (460) and the communication device (470) via the server (430). More specifically, all communications between the first communication device (410) and addressable devices (450) and (460) and communication device (470) are routed through the server (430).

Message time stamps of messages transmitted from the first communication device (410) are encrypted through the use of a private key. As described in FIGS. 1-3, the element of the message that is encrypted is the time stamp. More specifically, an encryption manager (422) is provided local to the first communication device (410) to encrypt the time stamp into the created message. The encrypted message time stamp is received by the server prior to being forwarded to the recipient. More specifically, server (430) is provided with a verification manager (480) to verify the authenticity of the time stamp. More specifically, the verification manager determines if the time stamp is within a valid age window. An acceptance manager (482) is provided in communication with the verification manager (480). The acceptance manager (482) functions to either accept the message if the time stamp does fall within a valid age window, or to reject the message if the time stamp does not fall within a valid age window. In one embodiment, a rejection of the message includes an SMS message sent from the server (430) to the first communication device (410) indicating that the message has timed out. Accordingly, the server (430) contains the tools to verify, and accept or reject, the message based upon the encrypted time stamp.

As shown in FIG. 4, the server (430) receives and verifies the encrypted message time stamp. Once the message has been accepted, the server (430) completes the trans-mission to the address of the appropriate device. In an embodiment where the recipient is an addressable device in a home automation framework, the message is transmitted to the device to complete an associated transaction. Similarly, in an embodiment where the recipient is a portable communication device, the message is forwarded to the recipient for communication purposes.

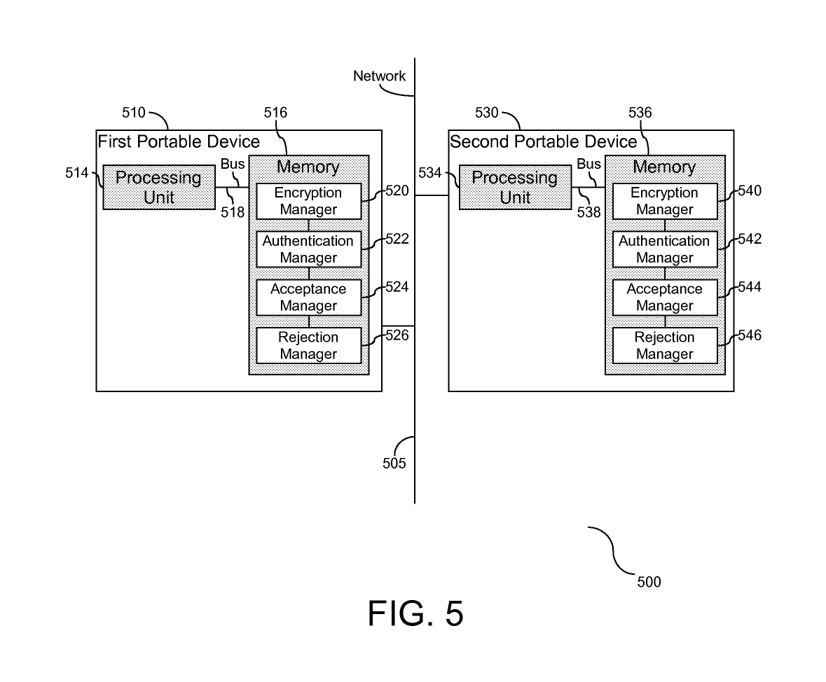

As illustrated in FIG. 2, in one embodiment, the encryption process may be based upon a direct communication between portable communication devices. FIG. 5 is a block diagram (500) illustrating tools embedded in a system to support encryption of SMS based messages for two or more communication devices. More specifically, a communication system is shown with a first portable communication device (510) in communication with a second portable communication device (530) across a network (505). The first portable communication device (510) is provided with a processing unit (514), in communication with memory (516) across a bus (518). At the same time, the second communication device (530) is provided with a processing unit (534), in communication with memory (536) across a bus (538). Each of the first and second portable communication devices (510) and (530) are also provided with tools to support transmission and receipt of telecommunications and SMS based messages. Communications between the portable communication devices (510) and (530) may be via a direct route.

As shown in FIG. 5, each of the communication devices (510) and (530) are provided with tools to support direct communication. More specifically, the communication devices each include an embedded encryption manager (520) and (540), respectively, an embedded authentication manager (522) and (542), respectively, an embedded acceptance manager (524) and (544), respectively, and an embedded rejection manager (526) and (546), respectively. The encryption managers (520) and (540) provide encryption services to encrypt a message time stamp or password; the authentication managers (522) and (542) function to authenticate the encrypted element of the message, including, but not limited to the time stamp and password; and the acceptance managers (524) and (544) function to satisfy the functionality of a message that is determined to be within a valid age window. Conversely, rejection managers (526) and (546) function to reject or otherwise communicate to the sending device(s) that the message has not been verified as a valid message. Accordingly, to support encryption and authentication of transmitted messages the managers may be embedded local to the recipient device.

As identified above, the system includes several managers to support encryption and verification. The encryption managers (520), (540), authentication managers (522), (542), acceptance managers (524), (544) and rejection managers (526), (546) function to manage encryption of a message time stamp to support authentication of the encrypted message time stamp. The managers are shown residing in memory local to the communication devices, addressable elements, and the server. More specifically, encryption managers (520), (540), authentication managers (522), (542), acceptance manager (524), (544), and rejection managers (526), (546) each reside in memory (506) of the respective communication device (510), (530). Although in one embodiment, the encryption, authentication, acceptance, and rejection managers may reside as hardware tools external to their local memory, or they may be implemented as a combination of hardware and software. Similarly, in one embodiment, the managers may be combined into a single functional item that incorporates the functionality of the separate items. As shown herein, each of the manager(s) are shown local to the respective device, whether in the form of a communication device, server, or an addressable element in a home automation framework. However, in one embodiment they may be collectively or individually distributed across the network and function as a unit to manage encryption and verification to support transmission of a message. Accordingly, the managers may be implemented as software tools, hardware tools, or a combination of software and hardware tools.

As will be appreciated by one skilled in the art, aspects of the present invention may be embodied as a system, method or computer program product. Accordingly, aspects of the present invention may take the form of a hardware embodiment, a software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like, and conventional procedural programming languages, such as the C programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

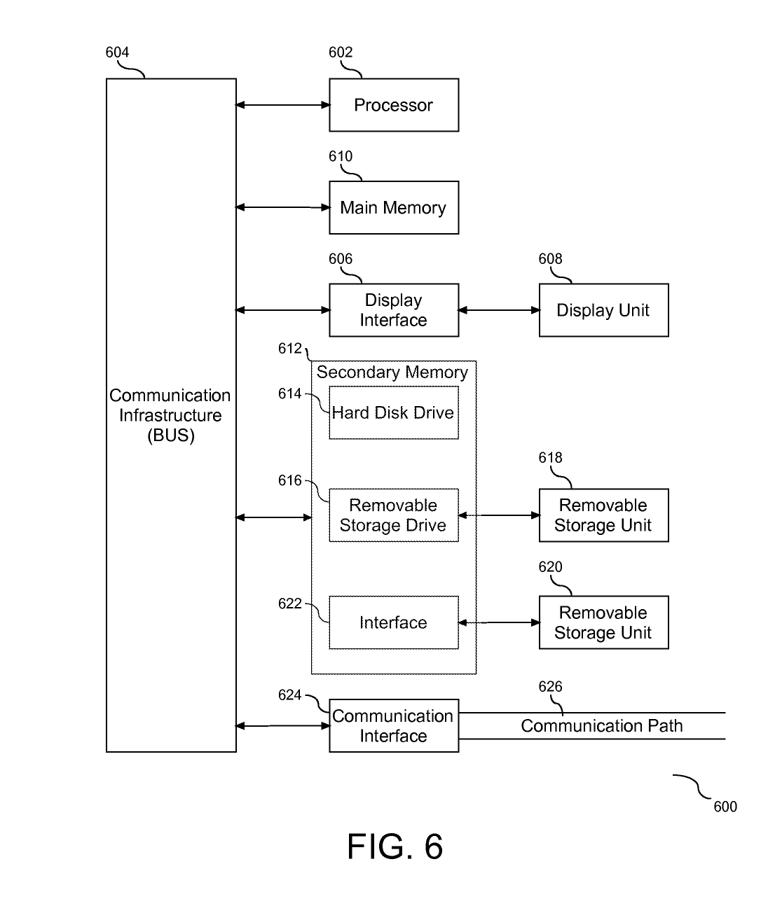

Referring now to FIG. 6 is a block diagram showing a system for implementing an embodiment of the present invention. The computer system includes one or more processors, such as a processor (602). The processor (602) is connected to a communication infrastructure (604) (e.g., a communications bus, cross-over bar, or network).

The computer system can include a display interface (606) that forwards graphics, text, and other data from the communication infrastructure (604) (or from a frame buffer not shown) for display on a display unit (608). The computer system also includes a main memory (610), preferably random access memory (RAM), and may also include a secondary memory (612). The secondary memory (612) may include, for example, a hard disk drive (614) and/or a removable storage drive (616), representing, for example, a floppy disk drive, a magnetic tape drive, or an optical disk drive. The removable storage drive (616) reads from and/or writes to a removable storage unit (618) in a manner well known to those having ordinary skill in the art. Removable storage unit (618) represents, for example, a floppy disk, a compact disc, a magnetic tape, or an optical disk, etc., which is read by and written to by removable storage drive (616). As will be appreciated, the removable storage unit (618) includes a computer readable medium having stored therein computer software and/or data.

In alternative embodiments, the secondary memory (612) may include other similar means for allowing computer programs or other instructions to be loaded into the computer system. Such means may include, for example, a removable storage unit (620) and an interface (622). Examples of such means may include a program package and package interface (such as that found in video game devices), a removable memory chip (such as an EPROM, or PROM) and associated socket, and other removable storage units (620) and interfaces (622) which allow software and data to be transferred from the removable storage unit (620) to the computer system.

The computer system may also include a communications interface (624). Communications interface (624) allows software and data to be transferred between the computer system and external devices. Examples of communications interface (624) may include a modem, a network interface (such as an Ethernet card), a communications port, or a PCMCIA slot and card, etc. Software and data transferred via communications interface (624) are in the form of signals which may be, for example, electronic, electromagnetic, optical, or other signals capable of being received by communications interface (624). These signals are provided to communications interface (624) via a communications path (i.e., channel) (626). This communications path (626) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (610) and secondary memory (612), removable storage drive (616), and a hard disk installed in hard disk drive (614).

Computer programs (also called computer control logic) are stored in main memory (610) and/or secondary memory (612). Computer programs may also be received via a communication interface (624). Such computer programs, when run, enable the computer system to perform the features of the present invention as discussed herein. In particular, the computer programs, when run, enable the processor (602) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### ALTERNATIVE EMBODIMENT

It will be appreciated that, although specific embodiments of the invention have been described herein for purposes of illustration, various modifications may be made without departing from the spirit and scope of the invention. In particular, although a set quantity of communication devices, servers, and addressable devices are shown in the example to support transmission of encrypted communication, the invention should not be limited to the quantity shown herein. In one embodiment, the network may be expanded to include additional servers, and communication and addressable devices. Conversely, the network may be reduced to a minimum of two elements, including a trans-mission device and a receiving device, wherein each of the elements are configured to support the encryption and verification elements of the message based communication. Additionally, any convenient encryption scheme may be employed with any representation of a time stamp when embodying this invention. Accordingly, the scope of protection of this invention is limited only by the following claims and their equivalents.

I claim:

1. A method for transmitting messages comprising:
providing a first communication device in communication with a second communication device;
said first communication device transmitting a message to said second communication device, said message including an encrypted time stamp;
authenticating said time stamp and determining whether said authenticated time stamp falls within a predetermined time interval;
said second communication device accepting said message in response to a determination that said time stamp falls within a predetermined time interval; and
said second communication device rejecting said message in response to a determination that said time stamp does not fall within said predetermined interval.

2. The method of claim 1, wherein said first and second communication devices are selected from the group consisting of: an electrical home appliance and a mobile communication device.

3. The method of claim 1, further comprising said first communication device encrypting said time stamp into said message.

4. The method of claim 1, further comprising said second communication device authenticating said time stamp of said message.

5. The method of claim 1, further comprising a first password unique to said first communication device and encrypting said time stamp with said first unique password, and a second password unique to said second communication device and authenticating said time stamp with said second unique password.

6. The method of claim 5, further comprising determining validity of said password and said encrypted time stamp prior to said second communication device accepting said message.

7. A system comprising:
a first communication device in communication with a second communication device across a network;
a first message transmitted from the first communication device to the second communication device, the first message including an encrypted time stamp;
an authentication manager to authenticate said time stamp and to determine whether the verified time stamp falls within a predetermined time interval;
an acceptance manager local to said second communication device to accept said message in response to a determination by said authentication manager that said time stamp falls within a predetermined time interval; and
a rejection manager local to said second communication device to reject said message in response to a determination by said authentication manager that said time stamp does not fall within said predetermined time interval.

8. The system of claim 7, wherein said first and second communication devices are selected from the group consisting of: an electrical home appliance and a mobile communication device.

9. The system of claim 7, further comprising an encryption manager local to said first communication device to encrypt said time stamp into said message.

10. The system of claim 7, further comprising said authentication manager local to said second communication device to authenticate said time stamp of said message.

11. The system of claim 7, further comprising a first password unique to said first communication device and said encryption manager to encrypt said time stamp with said first unique password, and a second password unique to said second communication device and said authentication manager to authenticate said time stamp with said second unique password.

12. The system of claim 11, further comprising a validity manager to determine validity of said password and said encrypted time stamp prior to said second communication device accepting said message.

13. A computer program product, the computer program product comprising a computer readable storage medium having computer readable program code embodied therewith, the computer readable program code comprising:
computer readable program code configured to transmit a message from a first communication device to a second communication device, said message including an encrypted time stamp;
computer readable program code configured to verify said time stamp and to determine whether the verified time stamp falls within a predetermined time interval;
said second communication device to accept said message in response to a determination that said time stamp falls within said predetermined time interval and to reject said message in response to a determination that said time stamp does not fall within said predetermined time interval.

14. The computer program product of claim 13, wherein said first and second communication devices are selected from the group consisting of: an electrical home appliance and a mobile communication device.

15. The computer program product of claim 13, further comprising computer readable program code local to said first communication device to encrypt said time stamp into said message.

16. The computer program product of claim 13, further comprising computer readable program code local to said second communication device to verify said time stamp embedded with said message.

17. The computer program product of claim 13, further comprising computer readable program code to create a first password unique to said first communication device and to encrypt said time stamp with said first unique password, and computer readable program code to create a second password unique to said second communication device and to verify said time stamp with said second unique password.

18. The computer program product of claim 17, further comprising computer readable program code to determine validity of said password and said encrypted time stamp prior to said second communication device accepting said message.
